(19) United States
(12) Patent Application Publication
(10) Pub. No.: US 2026/0357620 A1
(43) Pub. Date: Nov. 12, 2026

(54) Hand Restraints with Magnetic Biasing

(71) Applicants: Hector Castro, Oceanside, CA (US); Brenda Y. Castro, Oceanside, CA (US)

(72) Inventors: Hector Castro, Oceanside, CA (US); Brenda Y. Castro, Oceanside, CA (US)

(21) Appl. No.: 19/675,435

(22) Filed: May 12, 2026

Related U.S. Application Data
(60) Provisional application No. 63/804,383, filed on May 12, 2025.

(51) Int. Cl. E05B 75/00

(52) U.S. Cl. CPC E05B 75/00

(57) ABSTRACT

A handcuff apparatus includes a body with an interior chamber, a double strand coupled to the body, and a single strand rotationally coupled to the double strand with a ratchet at its distal end. A spring-biased pawl within the chamber engages the ratchet when closed. At least one magnetic element generates an attractive force urging the single strand's distal end toward the opening and into pawl engagement as the handcuff closes, allowing the user to apply the handcuff without direct visual observation. Multiple configurations are disclosed: magnetization of the distal end, magnetization of the pawl, opposite-pole magnetization of both components to maximize biasing force and assist opening, discrete magnets on the strand and body, a rotational biasing spring at the coupling, and a secondary biasing mechanism. The invention is compatible with conventional pawl-and-ratchet locking mechanisms and double-lock features.

### FIELD OF THE INVENTION

This application claims priority to U.S. Provisional Patent Application Ser. No. 63/804,383 filed on May 12, 2025.

The present invention relates generally to the field of hand restraints, such as those employed by law enforcement and security personnel. More particularly, it relates to an improved handcuff having magnetic biasing of the single strand or rotary arm into contact with the pawl, providing a closing force that assists the user in engaging the ratchet mechanism without requiring direct visual observation of the handcuff during application.

### BACKGROUND OF THE INVENTION

Modern handcuffs have become essential tools used by law enforcement to ensure the safety and security of both officers and detained persons. Over the years, the design and functionality of handcuffs have evolved, incorporating advanced materials and engineering to enhance their durability and reliability. Most modern handcuffs are constructed from high-strength steel or alloy, making them resistant to tampering, bending, or breaking while maintaining a relatively lightweight design.

Contemporary handcuffs typically include a double-locking mechanism which prevents accidental tightening of the cuffs and reduces the risk of injury to the individual being restrained. Many designs also feature a self-tightening ratchet mechanism which automatically adjusts the cuffs for a secure fit. The ratchet engagement is conventionally maintained by a spring-loaded pawl housed within the body of the handcuff, which engages teeth formed on the distal end of a rotating single strand member as that member is rotated into the closed position.

A persistent problem with conventional handcuff designs is encountered in dynamic use situations where the applying officer cannot directly view the handcuff body and the rotating single strand during closure. Such situations arise frequently during arrests, where the subject's hands are behind their back, in low-light environments, or where the subject is moving or resisting. In these circumstances, the distal end of the single strand must be guided into alignment with the entry aperture of the pawl housing by tactile feel alone. This task is made more difficult by any looseness in the rotational coupling of the single strand, which can allow the distal end to move out of plane with the entry aperture, and by the absence of any biasing force in the conventional design that would draw the single strand toward the closed position.

No biasing force toward closure exists in conventional handcuff designs. The spring-loaded pawl provides a biasing force only after the ratchet has already entered the pawl housing and made initial contact with the pawl. Prior to that contact, the single strand is entirely unbiased and relies solely on the physical manipulation of the user to align and introduce the ratchet into the pawl opening.

With respect to the above, before explaining at least one preferred embodiment of the magnetically biased handcuff device and system it is to be understood that the handcuff device and system herein is not limited in its application to the details of employment and to the arrangement of the components or the steps set forth in the following description or illustrated in the drawings. The various components, configurations, and steps of the herein disclosed handcuffs with magnetic biasing are capable of other embodiments, and of being practiced and carried out in various ways, all of which will be obvious to those skilled in the art once the information herein is reviewed.

Also, it is to be understood that the phraseology and terminology employed herein are for the purpose of description of the handcuff device and system herein and should not be regarded as limiting. As such, those skilled in the art will appreciate that the conception upon which this disclosure is based may readily be utilized as a basis for other magnetically biased handcuff systems. It is important, therefore, that the embodiments, objects and claims herein, be regarded as including such equivalent construction and methodology insofar as they do not depart from the spirit and scope of the present invention.

### SUMMARY OF THE INVENTION

The present invention provides a magnetically biased handcuff apparatus which addresses the deficiencies of conventional handcuff designs by incorporating at least one magnetic element that generates a magnetic attractive force urging the distal end of the single strand toward the entry aperture of the pawl housing and into ratcheted engagement with the pawl as the single strand is rotated toward the closed position.

In a basic aspect, the handcuff apparatus of the present invention comprises a body having an interior chamber and an opening communicating with said chamber, a double strand coupled to said body, a single strand rotationally coupled to said double strand and having a ratchet at its distal end, a spring-biased pawl disposed within the interior chamber and configured to engage the ratchet in the closed position, and at least one magnetic element configured to generate a magnetic attractive force urging the distal end of the single strand toward the opening and into engagement with the pawl as the single strand approaches the closed position.

The magnetic biasing force of the present invention operates as an approach force—that is, it acts on the distal end of the single strand before and during entry of the ratchet into the opening, providing guidance and closure assistance that is entirely absent from conventional spring-pawl designs. Once the ratchet enters the opening and contacts the pawl, the conventional spring-pawl ratchet engagement mechanism operates as in standard handcuffs. The magnetic biasing of the present invention is therefore additive to and compatible with existing handcuff locking mechanisms including double-lock features.

The magnetic biasing may be achieved through several configurations. In a first configuration, the distal end of the single strand is magnetized or formed of magnetic material, and the magnetic attraction between the distal end and the ferromagnetic metal of the body and double strand provides the biasing force. In a second configuration, the pawl is magnetized or formed of magnetic material, and the magnetic attraction between the pawl and the magnetically attractive distal end of the single strand provides the biasing force. In a third configuration, both the distal end of the single strand and the pawl are magnetized with opposite magnetic poles facing one another, maximizing the biasing force. In a fourth configuration, discrete magnets are coupled to both the distal end of the single strand and to the body adjacent the opening, with opposite poles facing one another. In a fifth configuration, a rotational biasing spring is additionally provided at the rotational coupling to bias the single strand toward the open position after the key disengages the pawl, facilitating faster unlocking.

In certain embodiments, the magnetic poles of the pawl are arranged so that the pole facing the opening is opposite to the pole of the distal end of the single strand, providing maximum attractive force during closure, while the opposite pole of the pawl faces away from the opening with the same polarity as the distal end. Upon key-actuated disengagement of the pawl from the ratchet, this same-polarity pole of the pawl repels the distal end of the single strand, providing an additional force assisting the opening of the handcuff.

The magnetic elements of the present invention may comprise rare earth magnets, preferably neodymium magnets, which provide high magnetic field strength in a compact form suitable for integration into handcuff components. The magnetic elements may be embedded within the components, surface-mounted thereto, or the components themselves may be formed of magnetic material. All magnetic elements are preferably encapsulated or coated to protect against corrosion and to prevent interference with the key-actuated locking mechanism.

The handcuff apparatus of the present invention is configured to operate in a manner substantially identical to conventional handcuffs from the perspective of the user, requiring no additional training or modification of technique beyond positioning the single strand proximate to the body, whereupon the magnetic biasing force assists in guiding and closing the handcuff. In a further aspect, the invention provides a handcuff set comprising a first handcuff apparatus and a second handcuff apparatus each as described herein, connected to one another by a chain coupled to each handcuff by a swiveled coupling.

In a still further aspect, the invention provides a method of restraining a person using the handcuff apparatus of the present invention, comprising positioning the single strand adjacent a wrist or ankle of the person and rotating the single strand toward the closed position, wherein the magnetic attractive force urges the distal end of the single strand through the opening and into ratcheted engagement with the pawl without requiring direct visual observation of the handcuff by the user.

With respect to the above description, before explaining at least one preferred embodiment of the magnetically biased handcuffs invention herein, it is to be understood that the invention is not limited in its application to the details of operation nor the arrangement of the components or the steps set forth in the following description or illustrations in the drawings. The various methods of implementation and operation of the handcuff device and system herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other magnetically biased handcuff devices and systems for employment for the purpose intended herein.

It is an object of this invention to provide handcuffs which are magnetically biased toward a locking position to enable users to more easily employ them, when not in view during closure.

It is a further object of this invention to provide such magnetically biased handcuffs which operate in a similar manner to existing handcuffs to enable widespread use.

These, together with other objects and advantages, which will become subsequently apparent, reside in the details of the construction and operation of the magnetically biased handcuff device and system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification, wherein a detailed description is for the purpose of fully disclosing the invention without placing limitations thereon.

### BRIEF DESCRIPTION OF THE DRAWING FIGURES

The accompanying drawings, which are incorporated herein and form a part of the specification, illustrate preferred embodiments of the magnetically biased handcuff device and system herein. It is intended that the embodiments and figures disclosed herein are to be considered illustrative of preferred modes rather than limiting.

FIG. 1 is an exterior view of the handcuff apparatus herein, showing a first handcuff in the closed position and a second handcuff in the open position, with the magnetically attractive distal end of the single strand visible on the open handcuff.

FIG. 2 is a perspective view with sectional detail showing both handcuffs of a handcuff set, depicting a first configuration wherein the distal end of each single strand carries a magnet and is magnetically biased toward engagement with the pawl to the locked position, with N and S pole designations shown on the single strand.

FIG. 3 is a sectional view of a second configuration of the handcuff apparatus herein, wherein the pawl is formed as or carries a magnet and the distal end of the single strand is magnetically attractive, providing magnetic biasing of the single strand toward the pawl.

FIG. 4 is a sectional view of a third configuration of the handcuff apparatus herein, wherein both the pawl and the distal end of the single strand are magnetized with opposite magnetic poles facing one another, maximizing the magnetic biasing force toward closure and providing a repulsive force to assist opening upon key actuation.

FIG. 5 is a sectional view of a fourth configuration of the handcuff apparatus herein, wherein discrete individual magnets are coupled to both the distal end of the single strand and to the double strand body adjacent the opening to the pawl, with opposite poles facing one another to provide the magnetic biasing force.

FIG. 6 is a sectional view of a fifth configuration of the handcuff apparatus herein, wherein a rotational biasing spring is operatively positioned at the rotational coupling of the single strand to the double strand, and wherein the distal end of the single strand is additionally magnetized, the spring providing a biasing force toward the open position upon key-actuated disengagement of the pawl.

FIG. 7 is an exterior view of the handcuff apparatus herein showing a secondary biasing mechanism operatively engaged with the body of each handcuff to bias the single strand toward the unlocked position, which secondary biasing mechanism may be employed in combination with any of the configurations shown in FIGS. 1 through 6.

FIG. 8 is a sectional view of a fourth configuration of the handcuff showing that the magnet may be coupled to the single strand by insertion into a recess and the attractive magnet may be positioned within a recess in a side surface of the double strand.

FIG. 9 shows a configuration of the handcuff herein having magnets positioned within recesses on one or both sides of the single strand and on a facing surface of one or both of the double strands.

### DETAILED DESCRIPTION OF THE PREFERRED EMBODIMENTS

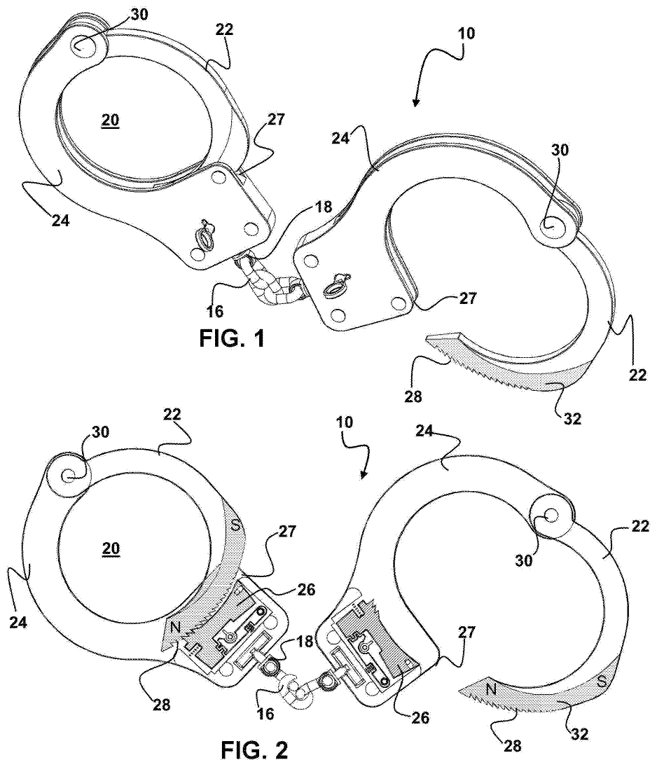

Referring now to the magnetically biased handcuff apparatus 10 depicted in FIGS. 1 through 7, wherein like reference numerals identify like components throughout, there is described a handcuff apparatus having magnetic biasing of the single strand toward the closed and locked position. The handcuff apparatus 10 is constructed of metal, preferably high-strength steel or alloy, and is configured for use by law enforcement, security personnel, and similar users.

As shown in FIG. 1, a first handcuff 12 is connected to a second handcuff 14 by a chain 16 coupled to each handcuff by a swiveled coupling 18, forming a handcuff set 10. Each handcuff comprises a body having an interior chamber, a double strand 24 comprising a pair of parallel curved members coupled to or integral with the body, and a single strand 22 having a proximal end rotationally coupled to the double strand 24 at a rotational coupling 30. The single strand 22 is rotatable between an open position, wherein a gap is formed allowing entry of a wrist or other body part into the interior cavity 20, and a closed position, wherein the interior cavity 20 is fully encircled.

The distal end of the single strand 22, opposite the rotational coupling 30, carries a ratchet 28 formed thereon. An entry opening 27 is formed in the body providing access to a pawl 26 slidably disposed within the interior chamber. The pawl 26 is biased toward an engagement position by a biasing spring (not separately numbered) such that as the ratchet 28 on the distal end of the single strand 22 enters the opening 27, the pawl 26 deflects to allow the ratchet teeth to pass and then re-engages, locking the single strand 22 in the closed position. Unlocking is accomplished by a key which rotates the pawl 26 out of engagement with the ratchet 28 in the conventional manner. The magnetic biasing described in each embodiment below is additive to and fully compatible with this conventional pawl-and-ratchet locking mechanism, including any double-lock feature that may be incorporated into the pawl assembly.

In the first embodiment, depicted in FIGS. 1 and 2, the distal end of the single strand 22 in the area of the ratchet 28 is magnetized or formed of magnetic material, indicated by reference numeral 32. As the single strand 22 is rotated toward the closed position and the distal end approaches the opening 27, the magnetic field of the magnetized distal end 32 is attracted to the ferromagnetic metal forming the body and double strand 24 adjacent the opening 27. This magnetic attractive force provides a biasing force urging the distal end of the single strand 22 toward and through the opening 27, guiding the ratchet 28 into contact with the pawl 26 without requiring precise visual alignment by the user.

As shown in FIG. 2, the N and S poles of the magnet 32 at the distal end of the single strand 22 are oriented to maximize attraction toward the body. The user need only position the distal end of the single strand 22 proximate to the opening 27, whereupon the magnetic force will act to urge the distal end into the opening 27, after which the user may apply a closing push to engage the ratchet 28 fully with the pawl 26. The magnet 32 may be a rare earth magnet, preferably a neodymium magnet, embedded within or surface-mounted to the distal end of the single strand 22, or the distal end may be formed entirely of magnetic material.

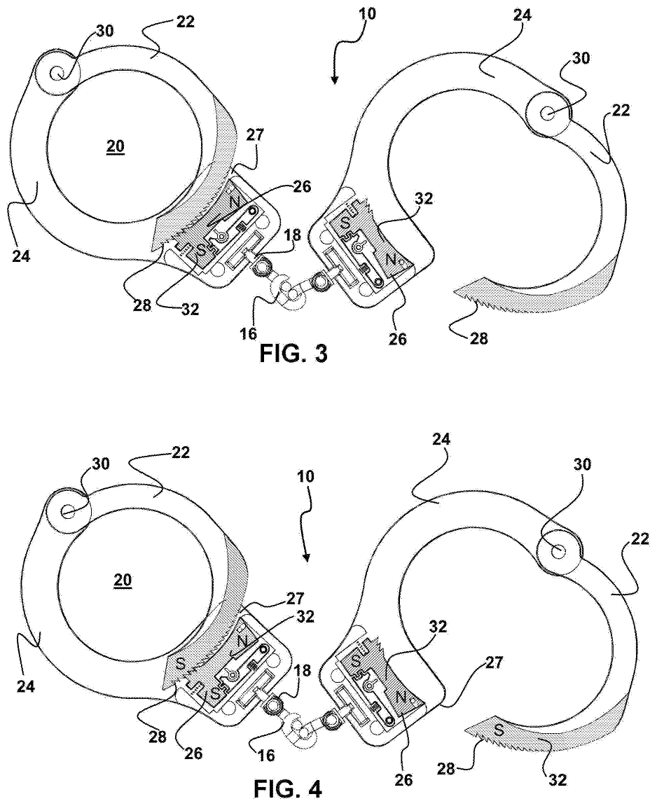

In the second embodiment, shown in FIG. 3, the pawl 26 is formed as or carries a magnet 32, while the distal end of the single strand 22 is formed of or carries magnetically attractive ferromagnetic material. In this configuration, the magnetic field of the magnetized pawl 26 extends through the opening 27 and attracts the ferromagnetic distal end of the single strand 22 as it approaches the opening 27 during rotation toward the closed position. This configuration provides the magnetic biasing force by making the pawl itself the source of the magnetic field rather than the single strand, achieving substantially the same biasing result as the first embodiment through an alternative arrangement.

In the third embodiment, depicted in FIG. 4, both the pawl 26 and the distal end of the single strand 22 are formed as magnets 32, with opposite magnetic poles on the facing surfaces to maximize the attractive force between them. As shown in FIG. 4, the magnetic pole of the pawl 26 on the side facing the opening 27 is opposite to the magnetic pole of the distal end of the single strand 22 facing the opening 27. For example, if the distal end of the single strand 22 presents a South pole toward the opening 27, the face of the pawl 26 adjacent the opening 27 presents a North pole, such that opposite poles attract and the biasing force urging the distal end of the single strand 22 toward and through the opening 27 is maximized.

In this third embodiment, the pawl 26 may be further magnetized such that the second side thereof, opposite the first side facing the opening 27, has the same polarity as the pole of the distal end of the single strand 22. In this arrangement, upon key-actuated disengagement of the pawl 26 from the ratchet 28, the same-polarity pole on the second side of the pawl 26 repels the distal end of the single strand 22, providing an additional force assisting movement of the single strand 22 toward the open position and facilitating faster disconnection.

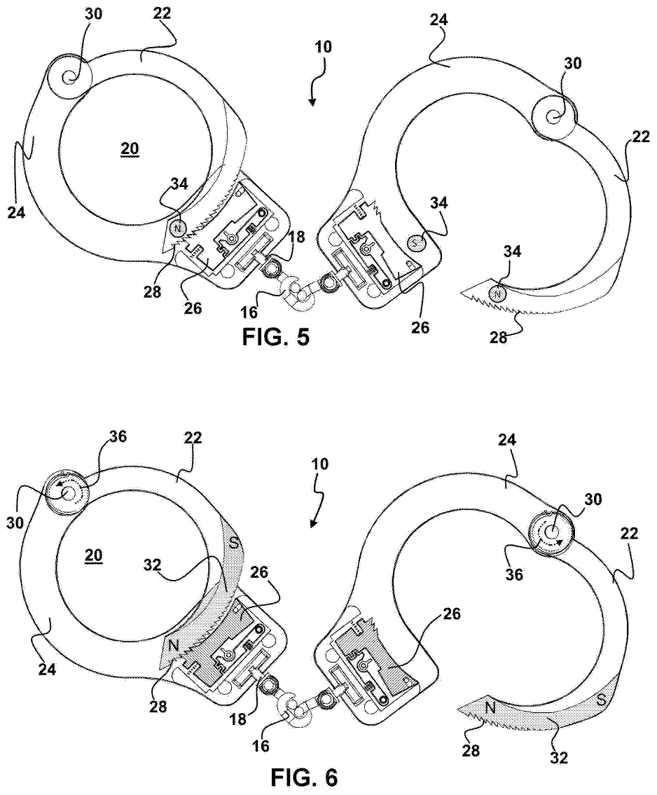

In the fourth embodiment, shown in FIG. 5, discrete individual magnets 34 are coupled to both the distal end of the single strand 22 and to the double strand body adjacent the opening 27. The individual magnets 34 are oriented with opposite poles facing one another, such that the magnetic attractive force between the magnet 34 on the distal end of the single strand 22 and the magnet 34 on the body adjacent the opening 27 provides the biasing force urging the single strand 22 toward the closed position. This configuration allows the use of standardized magnet components engaged to existing handcuff structures without requiring the formation of the pawl or single strand itself from magnetic material.

In the fifth embodiment, depicted in FIG. 6, the distal end of the single strand 22 is magnetized as described in the first embodiment, and additionally a rotational biasing spring 36 is operatively positioned at the rotational coupling 30 of the single strand 22 to the double strand 24. The rotational spring 36 is configured in a fashion to bias the distal end of the single strand 22 away from the pawl 26 and the opening 27 toward the open position. As the user rotates the single strand 22 toward the closed position and the ratchet 28 passes through the opening 27, the rotational spring 36 is compressed. Upon key-actuated disengagement of the pawl 26 from the ratchet 28, the rotational spring 36 releases and biases the single strand 22 away from the pawl 26 toward the open position, facilitating faster and more positive unlocking. In this embodiment, the magnetic biasing force urges the single strand 22 toward closure during application, while the spring 36 assists opening upon release, providing an improved user experience in both directions of operation.

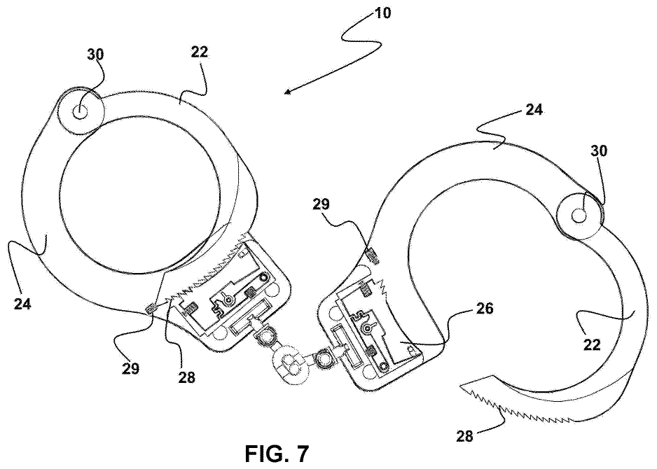

As shown in FIG. 7, a secondary biasing mechanism 29 may be operatively engaged with the body of the handcuff apparatus 10 to provide an additional biasing force urging the single strand 22 toward the open position. The secondary biasing mechanism 29 may comprise a leaf spring, torsion element, or other resilient member engaged between the body and the single strand 22 or rotational coupling 30. The secondary biasing mechanism 29 may be employed in combination with any of the configurations described in the first through fifth embodiments above, providing supplemental opening assistance in each case.

The magnetic elements employed in the handcuff apparatus 10 of the present invention preferably comprise rare earth magnets, most preferably neodymium magnets, which provide high magnetic field strength in a compact and lightweight form factor suitable for integration into handcuff components. The magnetic elements may be embedded within the relevant components, surface-mounted thereto using adhesive or mechanical fastening, or the components themselves may be formed entirely of magnetic material. All magnetic elements are preferably encapsulated within a non-magnetic coating or housing to protect against corrosion and physical damage, and to prevent stray magnetic fields from interfering with the key-actuated locking mechanism or with other ferromagnetic objects carried by the officer.

The strength of the magnetic elements is selected to provide a reliable approach biasing force sufficient to urge the distal end of the single strand 22 into the opening 27 when proximate thereto, without generating a force so strong as to prevent the user from rotating the single strand 22 to the open position when necessary. In practice, a magnetic attractive force in the range sufficient to begin guiding the distal end from a distance of approximately 5 to 15 millimeters from the opening 27 is preferred, though this range may be varied depending on the specific handcuff design and intended application.

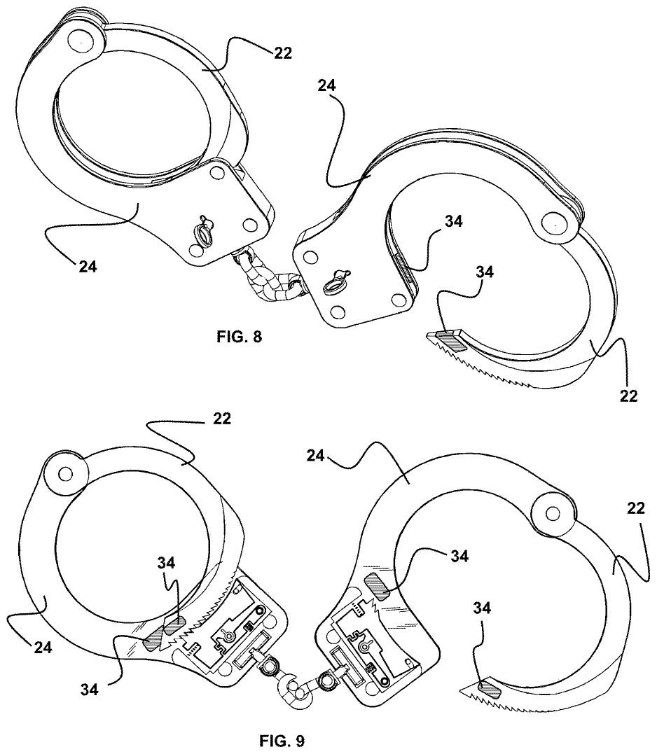

Shown in FIG. 8, is a configuration where a magnet 34 may be coupled to the single strand 22 by insertion into a recess and a second magnet 34 may be positioned within a recess in a side surface of the double strand.24 such that the magnet 34 on the single strand 22 is attracted or biased into the internal cavity between the double strands 24.

FIG. 9 is shown a similar configuration to that of FIG. 8, wherein an individual magnet 34 is positioned within a recess on one or both of the two opposing side surfaces of the single strand 22. FIG. 9 shows a configuration of the handcuff herein having magnets positioned within recesses on one or both sides of the single strand and on a facing surface of one or both of the double strands. The magnet 34 or magnets 34 on the surfaces of the single strand 22 are attracted to the magnet 34 or magnets 34 on one or both side surfaces of the double strand 22 to provide an attractive magnetic force or urging of the distal end of the single strand 22 into the internal cavity between the double strand 22 and toward the pawl.

The magnetic biasing of the present invention is fully compatible with conventional double-lock mechanisms that may be incorporated into the pawl assembly. The double-lock feature, which prevents further tightening of the handcuff after the double-lock is engaged, operates on the pawl 26 in a manner that is independent of the magnetic biasing of the distal end of the single strand 22. Engaging the double-lock does not affect the magnetic biasing force, and the magnetic biasing force does not interfere with the operation of the double-lock mechanism.

While all of the fundamental characteristics and features of the magnetically biased handcuff apparatus have been shown and described herein with reference to particular embodiments, a latitude of modification, various changes, and substitutions are intended in the foregoing disclosure. It will be apparent that in some instances, some features of the disclosed apparatus may be employed without a corresponding use of other features without departing from the scope of the invention. Various equivalent substitutions, modifications, and variations may be made by those skilled in the art without departing from the spirit or scope of the invention, and all such modifications are intended to be within the scope of the invention as defined by the claims that follow.

What is claimed is:

1. A handcuff apparatus comprising:
a double strand coupled to said body and forming a first portion of a wrist-encircling structure;
a single strand having a proximal end rotationally coupled to said double strand at a rotational coupling and a distal end having a ratchet formed thereon, said single strand rotatable between an open position and a closed position;
a pawl slidably disposed within said interior chamber and biased toward an engagement position, wherein in said engagement position said pawl engages said ratchet at said distal end of said single strand to retain said single strand in said closed position; and
at least one magnetic element configured to generate a magnetic attractive force urging said distal end of said single strand toward said opening and into engagement with said pawl as said single strand is rotated toward said closed position.

2. The handcuff apparatus of claim 1, wherein said at least one magnetic element comprises a magnet disposed at or adjacent said distal end of said single strand.

3. The handcuff apparatus of claim 2, wherein said magnet is embedded within said distal end of said single strand.

4. The handcuff apparatus of claim 2, wherein said magnet is surface-mounted to said distal end of said single strand.

5. The handcuff apparatus of claim 1, wherein said at least one magnetic element comprises a magnet disposed on or within said pawl.

6. The handcuff apparatus of claim 5, wherein said pawl is formed entirely of magnetic material.

7. The handcuff apparatus of claim 1, wherein said at least one magnetic element comprises a first magnet disposed at said distal end of said single strand and a second magnet disposed on or within said pawl, wherein said first magnet and said second magnet have opposite magnetic poles on the surfaces thereof facing one another, such that said magnetic attractive force between said first magnet and said second magnet urges said distal end of said single strand toward and through said opening into engagement with said pawl.

8. The handcuff apparatus of claim 7, wherein said pawl is further magnetized such that a first side of said pawl facing said opening has a first magnetic pole and a second side of said pawl opposite said first side has a second magnetic pole of opposite polarity to said first magnetic pole, and wherein said second magnetic pole is the same polarity as the pole of said first magnet on said distal end of said single strand facing said pawl, such that upon disengagement of said pawl from said ratchet by a key, said second magnetic pole of said pawl repels said distal end of said single strand to assist movement of said single strand toward said open position.

9. The handcuff apparatus of claim 1, wherein said at least one magnetic element comprises a first magnet coupled to said distal end of said single strand and a second magnet coupled to said body adjacent said opening, wherein said first magnet and said second magnet have opposite magnetic poles on the surfaces thereof facing one another.

10. The handcuff apparatus of claim 1, wherein said distal end of said single strand is formed of a magnetically attractive ferromagnetic material and said at least one magnetic element is disposed within said body adjacent said opening, such that said magnetic attractive force draws said distal end toward said opening as said distal end becomes proximate thereto.

11. The handcuff apparatus of claim 1, further comprising a biasing spring operatively engaged at said rotational coupling, wherein said biasing spring is configured to bias said single strand toward said open position, and wherein rotation of said single strand toward said closed position compresses said biasing spring, such that upon disengagement of said pawl from said ratchet by a key, said biasing spring urges said single strand toward said open position.

12. The handcuff apparatus of claim 11, wherein said biasing spring is a torsion spring disposed coaxially with said rotational coupling.

13. The handcuff apparatus of claim 1, further comprising a secondary biasing mechanism operatively engaged with said body and configured to bias said single strand toward said open position independently of said at least one magnetic element.

14. The handcuff apparatus of claim 13, wherein said secondary biasing mechanism comprises a leaf spring engaged between said body and said single strand.

15. The handcuff apparatus of claim 1, wherein said body further comprises a key-actuated lock configured to rotate said pawl out of engagement with said ratchet to permit movement of said single strand from said closed position to said open position, and wherein said at least one magnetic element does not interfere with operation of said key-actuated lock.

16. The handcuff apparatus of claim 1, wherein said body further comprises a double-lock mechanism configured to prevent further tightening of the handcuff apparatus after said double-lock mechanism is engaged, and wherein said at least one magnetic element does not interfere with operation of said double-lock mechanism.

17. The handcuff apparatus of claim 1, wherein said at least one magnetic element comprises a rare earth magnet.

18. The handcuff apparatus of claim 17, wherein said rare earth magnet is a neodymium magnet.

19. A handcuff set comprising:
a first handcuff apparatus according to claim 1;
a second handcuff apparatus according to claim 1; and
wherein said first handcuff apparatus and said second handcuff apparatus are connected to one another by a chain coupled to each by a swiveled coupling.

20. A method of restraining a person using a handcuff apparatus comprising a body having an interior chamber and an opening, a double strand, a single strand rotationally coupled to said double strand and having a ratchet at its distal end, a pawl within said interior chamber, and at least one magnetic element, said method comprising:
positioning said single strand adjacent a wrist or ankle of a person to be restrained;
rotating said single strand toward a closed position; and
allowing a magnetic attractive force generated by said at least one magnetic element to urge said distal end of said single strand toward said opening and into ratcheted engagement with said pawl to retain said single strand in said closed position, without requiring direct visual observation of said handcuff apparatus by the user during said rotating step.
